(19) United States
(12) Patent Application Publication
(10) Pub. No.: US 2008/0078743 A1
(43) Pub. Date: Apr. 3, 2008

(54) ELEVATED TEMPERATURE CHEMICAL OXIDE REMOVAL MODULE AND PROCESS

(76) Inventors: Andres F. Munoz, Yonkers, NY (US); Siddhartha Panda, Kanpur (IN); Michael R. Sievers, Poughkeepsie, NY (US); Richard Wise, Newburgh, NY (US)

Correspondence Address: HOFFMAN, WARNICK & D'ALESSANDRO LLC, 75 STATE ST, 14TH FL, ALBANY, NY, 12207, US

(21) Appl. No.: 11/536,388

(22) Filed: Sep. 28, 2006

(51) Int. Cl. C03C 25/68; B44C 1/22; C23F 1/00

(52) U.S. Cl. 216/58; 216/63; 216/80; 156/345.47

(57) ABSTRACT

A temperature-controlled substrate holder having a high temperature substrate chuck is mounted within a chemical treatment chamber. The temperature-controlled substrate holder secures a substrate and maintains the substrate at a temperature that ranges from about 10° C. up to about 150° C. during execution of a chemical oxide removal process.

### BACKGROUND OF THE INVENTION

1. Technical Field

This disclosure generally relates to treating a semiconductor substrate, and more specifically to treating the substrate with an elevated temperature chemical oxide removal process.

2. Background Art

In a typical chemical oxide removal process, a substrate transfer system moves a semiconductor substrate into a chemical treatment chamber. A substrate holder mounted in the chemical treatment chamber receives and secures the substrate. A vacuum pumping system, which can include a vacuum pump and gate valve, throttles the pressure of the chemical treatment chamber. A heating element heats the chemical treatment chamber to a predetermined chamber temperature, while a heating element within the substrate holder heats the substrate to a predetermined substrate temperature. A gas distribution system distributes one or more process gases into the chemical treatment chamber. Surface layers, such as oxide surface layers, on the substrate are exposed to the process gases for a predetermined time period. The oxide surface layers exposed to the process gases react and chemically alter the surface layers.

After the chemical oxide removal process has been performed, the substrate transfer system moves the substrate from the chemical treatment chamber to a thermal treatment chamber for further treatment. In particular, a substrate holder mounted in the thermal treatment chamber receives and secures the substrate. A gate valve assembly seals the thermal treatment chamber from the chemical treatment chamber. A vacuum pumping system that can include a vacuum pump and gate valve throttles the pressure of the thermal treatment chamber. A heating element heats the thermal treatment chamber to a predetermined chamber temperature. In addition, a heating element within the substrate holder heats the substrate to a predetermined substrate temperature for a predetermined time, which causes a crust of the chemically altered surface layers of the substrate to decompose and evaporate. The vacuum pump removes the remnants of the evaporated surface layers from the thermal treatment chamber. After the substrate has cooled off, the substrate transfer assembly moves the substrate from the thermal treatment chamber.

A limitation associated with currently available chemical oxide removal modules used to perform the chemical oxide removal process is that the substrate holder mounted in the chemical treatment chamber is only capable of maintaining the substrate at a temperature that ranges from about 10° C. up to about 30° C. during the process gas exposure phase. Maintaining the substrate at a temperature that generally ranges from about 10° C. up to about 30° C. translates to limited etching selectivity because temperature is a strong control of etch rate and also reactivity. Furthermore, etching rates are limited when the substrate is limited to a lower temperature range because thermodynamics limit reaction efficiency and rate.

### SUMMARY OF THE INVENTION

Therefore, there is a need for a chemical oxide removal module that can maintain the substrate in the chemical treatment chamber at an elevated temperature during the process gas phase of the chemical oxide removal process.

In one embodiment of the disclosure, there is a chemical oxide removal module. In this embodiment, the chemical oxide removal module comprises a chemical treatment chamber configured to execute a chemical oxide removal process on a substrate. A temperature-controlled substrate holder is mounted within the chemical treatment chamber. The temperature-controlled substrate holder is configured to maintain the substrate at a temperature that ranges from about 10° C. up to about 150° C. during execution of the chemical oxide removal process.

In another embodiment of the disclosure, there is a semiconductor treatment processing system for treating a substrate. In this embodiment, there is a chemical oxide removal module for executing a chemical oxide removal process on a substrate. The chemical oxide removal module comprises a chemical treatment chamber and a temperature-controlled substrate holder mounted within the chemical treatment chamber. The temperature-controlled substrate holder is configured to maintain the substrate at a temperature that ranges from about 10° C. up to about 150° C. during execution of the chemical oxide removal process. The semiconductor processing system further comprises a thermal treatment module for thermally treating the substrate after the chemical oxide removal module executes the chemical oxide removal process on the substrate.

In a third embodiment of the disclosure, there is a chemical oxide removal process. In this embodiment, the process comprises securing a substrate to a temperature-controlled substrate holder mounted within a chemical treatment chamber. The process further comprises adjusting the temperature-controlled substrate holder to an elevated temperature, wherein the elevated temperature ranges from about 10° C. up to about 150° C. The chemical oxide removal process further comprises distributing one or more process gases to the chemical treatment chamber. In addition, the process comprises exposing the substrate with the one or more process gases while the substrate is maintained at the elevated temperature for a predetermined amount of time.

### BRIEF DESCRIPTION OF THE DRAWINGS

FIG. 1 shows a schematic cross-sectional view of a semiconductor processing system comprising a chemical oxide removal module and a thermal treatment module;

FIG. 2 shows a flow chart describing the process performed by the chemical oxide removal module depicted in FIG. 1; and

FIG. 3 shows a flow chart describing the process performed by the thermal treatment module depicted in FIG. 1.

### DETAILED DESCRIPTION

The description that follows pertains to performing an elevated temperature chemical oxide removal process. A chemical oxide removal module performs the elevated temperature chemical oxide removal process and is part of an overall semiconductor treatment processing system. The semiconductor treatment processing system is part of a multi-element manufacturing system that can include additional semiconductor processing elements such as etching systems, deposition systems, coating systems, cleaning systems, polishing systems, patterning systems, metrology systems, alignment systems, lithography systems and transfer systems. The semiconductor treatment processing system includes a transfer module and a thermal treatment module in addition to the chemical oxide removal module. The transfer module, chemical oxide removal module and thermal treatment module function together to perform a removal process. The transfer module receives substrates from the multi-element manufacturing system and transfers them into and out of the modules for performing the removal process.

In one embodiment, the transfer module moves substrates rapidly through the thermal treatment module into the chemical oxide removal module. Once inside, the chemical oxide removal module performs a chemical oxide removal process on the substrate. The transfer module then moves the substrate back to the thermal treatment module which heats the surface layers on the substrate that have been chemically altered by the chemical oxide removal process. The heat applied in the thermal treatment module causes the chemically altered surface layers to decompose and evaporate. After the substrate has cooled, the transfer module then moves the substrate from the thermal treatment module and transfers it to another semiconductor processing element in the multi-element manufacturing system.

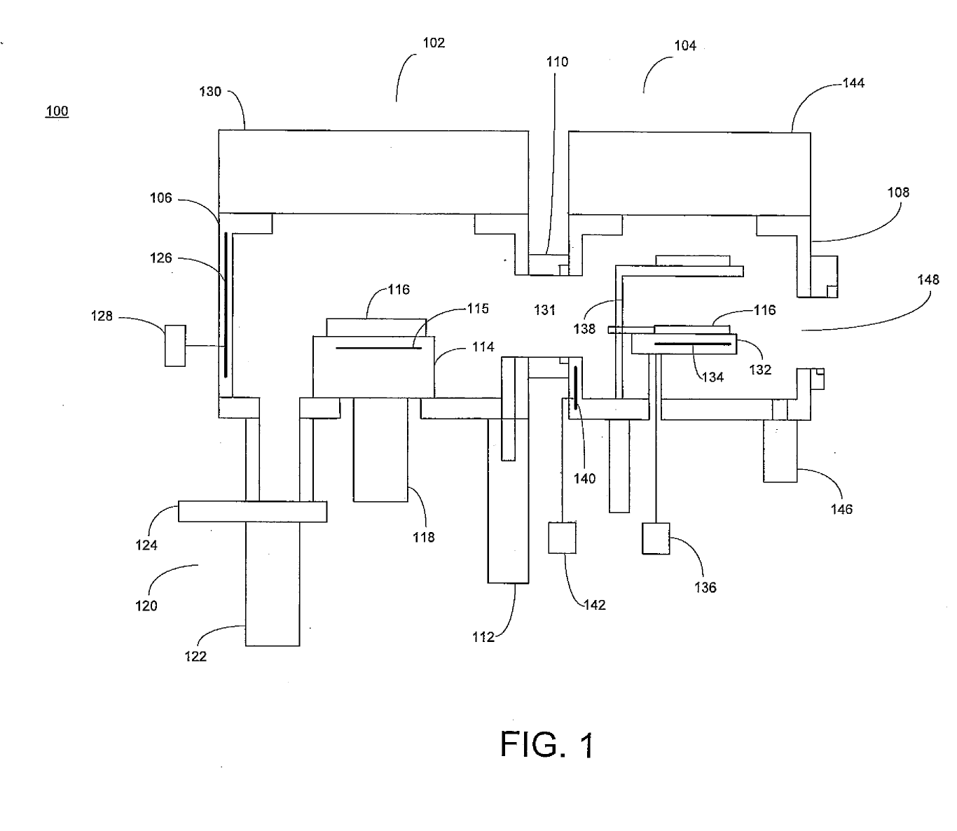

Referring now to the drawings, FIG. 1 shows a schematic cross-sectional view of a semiconductor treatment processing system 100 comprising a chemical oxide removal module 102 and a thermal treatment module 104 coupled to the chemical oxide removal module 102. For ease of illustration, FIG. 1 does not show the transfer module which transfers substrates in and out of modules 102 and 104. The chemical oxide removal module 102 comprises a chemical treatment chamber 106, which is temperature-controlled in one embodiment. The thermal treatment module 104 comprises a thermal treatment chamber 108, which is temperature-controlled in one embodiment. A thermal insulation assembly 110 thermally insulates the chemical treatment chamber 106 from the thermal treatment chamber 108. A gate valve assembly 112 vacuum isolates the chemical treatment chamber 106 from the thermal treatment chamber 108.

As shown in FIG. 1, the chemical oxide removal module 102 further comprises a temperature controlled substrate holder 114 mounted within the chemical treatment chamber 106. The temperature controlled substrate holder 114 is substantially thermally isolated from the chemical treatment chamber 106 and configured to support a substrate 116. The temperature-controlled substrate holder 114 comprises a high temperature substrate chuck that secures the substrate 116 to the holder. The high temperature substrate chuck maintains the substrate 116 at a temperature that ranges from about 10° C. up to about 150° C. during execution of the chemical oxide removal process in the chemical treatment chamber 106. Those skilled in the art will recognize that high temperature substrate chucks that can maintain a temperature that ranges from about 10° C. up to about 150° C. are commercially available.

The substrate holder 114 can provide several operational functions for thermally controlling and processing the substrate 116. For example, the substrate holder 114 can, for example, further include a heating element 115 embedded within the holder to provide heat to the high temperature substrate chuck and substrate 116. The substrate holder 114 can further include a cooling system having a re-circulating coolant flow that receives heat from the substrate holder 114 and transfers heat to a heat exchanger system (not shown), or when heating to the elevated temperature, transfers heat from the heat exchanger system.

The substrate holder 114 also can include a lift pin assembly (not shown) that raises and lowers three or more lift pins (not shown) in order to vertically translate the substrate 116 to and from an upper surface of the holder and a transfer plane in the system 100.

A substrate holder assembly 118 assists the substrate holder 114 in providing several operational functions for thermally controlling and processing the substrate 116. For example, the substrate holder assembly 118 can, for example, further include a temperature sensing device (not shown) such as a thermocouple that monitors the temperature of the substrate holder 114. In this embodiment, a controller (not shown) would receive temperature measurements from the temperature sensing device and use the measurements to control the temperature of substrate holder 114.

As shown in FIG. 1, the chemical oxide removal module 102 further comprises a vacuum pumping system 120 that comprises a vacuum pump 122 and a gate valve 124 for throttling the pressure of the chemical treatment chamber 106. A wall heating element 126 controlled by a wall temperature control unit 128, heats the chemical treatment chamber 106 to a predetermined chamber temperature. In one embodiment, the wall heating element 126 heats the chamber 106 to a temperature that ranges from about 10° C. up to about 150° C. In one embodiment, a temperature-sensing device (not shown) can monitor the temperature of the chemical treatment chamber 106 and send measurements to the wall temperature control unit 128 which will use the measurements to control the temperature of the chamber.

The chemical oxide removal module 102 further comprises a gas distribution system 130 that distributes one or more process gases into the chemical treatment chamber 106. The one or more process gases may include, for example, ammonia (NH₃), hydrofluoric acid (HF), hydrogen (H₂), oxygen (O₂), carbon monoxide (CO), carbon dioxide (CO₂), argon (Ar) or helium (He). In one embodiment, the gas distribution system 130 can include one or more gas distribution orifices (not shown) to distribute the one or more process gases to the process space within the chemical treatment chamber 106. In another embodiment, the gas distribution system 130 can comprise a showerhead gas injection system (not shown) to distribute the one or more process gases.

The chemical treatment chamber 106, thermal treatment chamber 108, and thermal insulation assembly 110 define a common opening 131 through which the substrate 116 can be transferred. During processing, the common opening 131 can be sealed closed using the gate valve assembly 112 in order to permit independent processing in chambers 106 and 108.

As shown in FIG. 1, the thermal treatment module 104 further comprises a temperature controlled substrate holder 132 mounted within the thermal treatment chamber 108. The temperature controlled substrate holder 132 is substantially thermally isolated from the thermal treatment chamber 108 and configured to support the substrate 116. The temperature-controlled substrate holder 132 comprises a high temperature substrate chuck that secures the substrate 116 to the holder. The high temperature substrate chuck maintains the substrate 116 at a temperature that can reach up to about 150° C., so that the chemically altered surface layers of the substrate can decompose and evaporate.

A heating element 134 embedded within the substrate holder 132, controlled by a substrate holder temperature control unit 136, provides the heat to the high temperature substrate chuck and the substrate 116. In one embodiment, a temperature-sensing device such as a thermocouple (not shown) monitors the temperature of the substrate holder 132 including the high temperature substrate chuck. The substrate holder temperature control unit 136 receives temperature measurements from the temperature-sensing device and controls the temperature of the substrate holder 132 based on the measurements.

As shown in FIG. 1, there is a substrate lifter assembly 138 that can rise to a transfer plane within the chamber 108 to receive substrates from the transfer module. In addition, the substrate lifter assembly 138 can lower and place the substrate 116 onto the high temperature chuck located on an upper surface of the substrate holder 132. After the substrate has been sufficiently heated so that the chemically altered surface layers of the substrate 116 decompose and evaporate, substrate lifter assembly 138 raises the substrate to the transfer plane where it cools before the transfer module transfers it off from system 100.

The thermal treatment module 104 further comprises a thermal wall heating element 140 controlled by a thermal wall temperature control unit 142, that heats the thermal treatment chamber 108 to a predetermined chamber temperature. In one embodiment, the thermal wall heating element 140 heats the chamber 108 to a temperature that ranges from about 10° C. up to about 150° C. In one embodiment, a temperature-sensing device (not shown) can monitor the temperature of the thermal treatment chamber 108 and send measurements to the thermal wall temperature control unit 142 which will use the measurements to control the temperature of the chamber.

As shown in FIG. 1, the thermal treatment module 104 further comprises an upper assembly 144. In one embodiment, the upper assembly 144 can comprise a gas injection system that introduces a purge gas, process gas, or cleaning gas to the thermal treatment chamber 108. In another embodiment, the upper assembly 144 can comprise a heating element or cooling element to heat or cool the thermal treatment chamber 108, respectively.

The thermal treatment module 104 further comprises a vacuum pumping system 146 that evacuates remnants of the evaporated surface layers from thermal treatment chamber 108. The vacuum pumping system 146 comprises a vacuum pump and a gate valve (not shown) for throttling the pressure of the chemical treatment chamber 106.

As shown in FIG. 1, the thermal treatment module 104 further comprises a transfer opening 148 formed in the thermal treatment chamber 108 in order to permit substrate exchanges with the transfer module. Although FIG. 1 shows the transfer opening 148 in the thermal treatment chamber 108, the opening may be formed in the chemical treatment chamber 106 or it may be formed in both chambers 106 and 108.

Although not shown in FIG. 1, the semiconductor treatment processing system 100 can comprise a controller that controls operations of the chemical oxide removal module 102, thermal treatment module 104 and the transfer module. In one embodiment, the controller can comprise a processor, memory, and a digital input/output port capable of exchanging information with the chemical oxide removal module 102, thermal treatment module 104 and the transfer module.

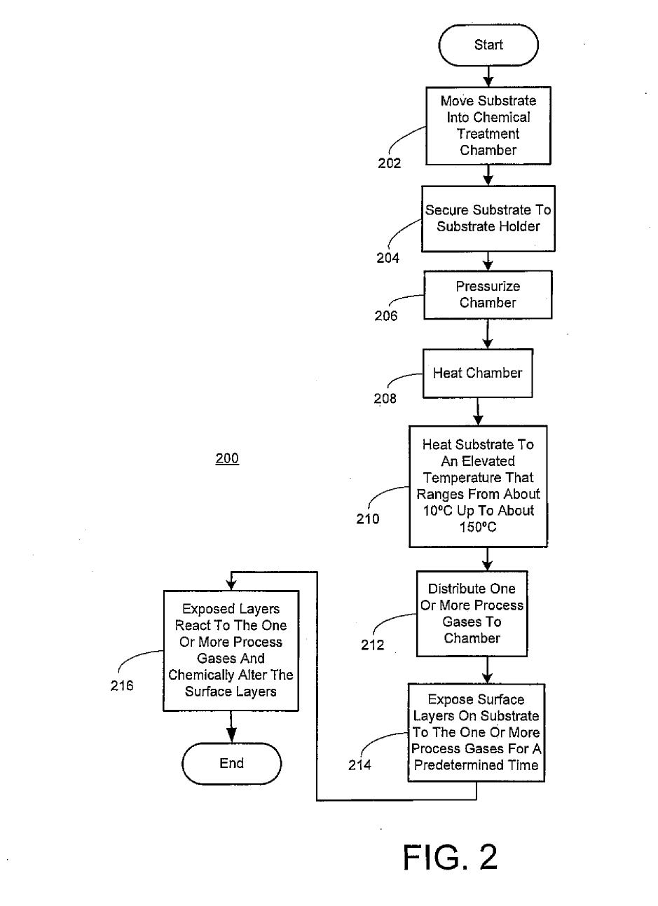

FIG. 2 shows a flow chart describing the process 200 performed by the chemical oxide removal module depicted in FIG. 1. At 202, the transfer module moves a substrate into the chemical treatment chamber. The substrate holder receives and secures the substrate at 204. The vacuum pumping system throttles the pressure of the chemical treatment chamber at 206. In one embodiment, the processing pressure can range from about 8 milliTorr (mTorr) to about 30 mTorr. The heating element heats the chemical treatment chamber to a predetermined chamber temperature at 208. In one embodiment, the predetermined chamber temperature can range from about 10° C. up to about 150° C. The heating element within the substrate holder heats the substrate via the high temperature chuck to an elevated temperature at 210. The elevated temperature ranges from about 10° C. up to about 150° C. Generally, one of skill in the art will select a temperature from this elevated temperature range based on the desired etching selectivity and etching rate that one wishes to obtain for a given application.

The gas distribution system distributes one or more process gases into the chemical treatment chamber at 212. In one embodiment, the process gas comprises HF and NH₃ and the flow rate at which the process gases enters the chemical treatment chamber ranges from about 1 standard cubic centimeters per minute (sccm) to about 200 sccm. Surface layers, such as oxide surface layers, on the substrate are exposed to the HF and NH₃ gases for a predetermined time period which can range from about 30 seconds to about 120 seconds at 214. The oxide surface layers exposed to the process gases react at 216 and chemically alter the surface layers of the substrate. The transfer module then moves the substrate from the chemical treatment chamber for treatment by the thermal treatment module.

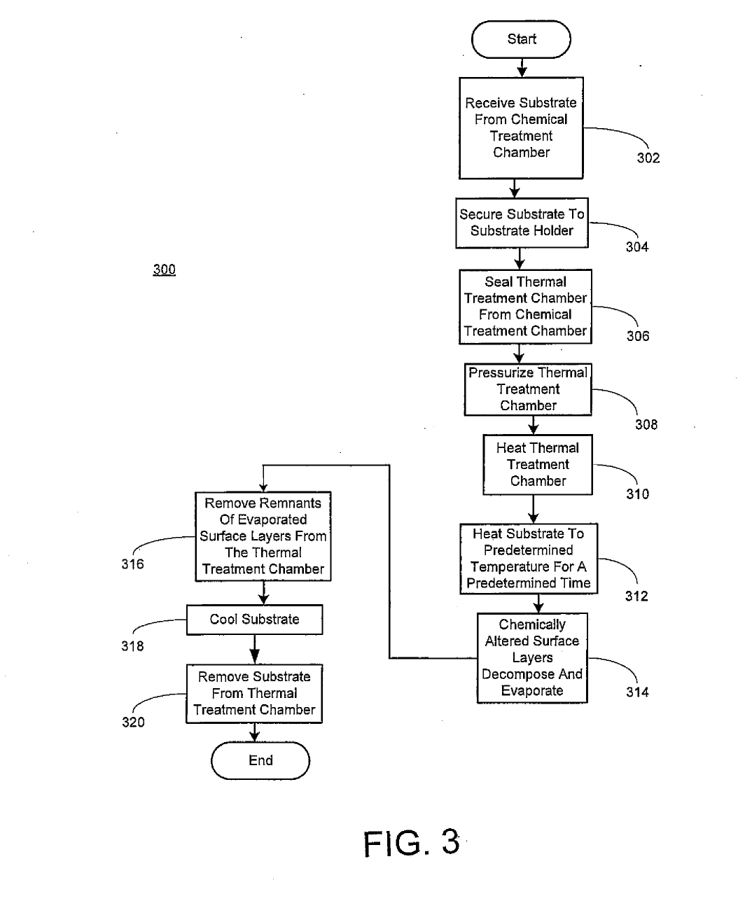

FIG. 3 shows a flow chart describing the process 300 performed by the thermal treatment module depicted in FIG. 1. At 302, the transfer module moves the substrate into the thermal treatment chamber for further treatment. The substrate holder in the thermal treatment chamber receives and secures the substrate at 304. The gate valve assembly seals the thermal treatment chamber from the chemical treatment chamber at 306. The vacuum pumping system throttles the pressure of the thermal treatment chamber at 308. In one embodiment, the processing pressure can range from about 10 mTorr to about 30 mTorr. The heating element heats the thermal treatment chamber to a predetermined chamber temperature at 310. In one embodiment, the predetermined chamber temperature can range from about 10° C. up to about 150° C.

The heating element within the substrate holder heats the substrate via the high temperature chuck to a predetermined temperature at 312. The predetermined temperature can range from about 100° C. up to about 200° C. A temperature in this range causes the chemically altered surface layers of the substrate to decompose and evaporate at 314. The vacuum pump removes the remnants of the evaporated surface layers from the thermal treatment chamber at 316. The substrate cools at 318 and the transfer module then removes the substrate from the thermal treatment chamber at 320. The transfer module then can transfer the substrate from the semiconductor treatment processing system to another semiconductor processing element in the multi-element manufacturing system.

The foregoing flow charts of FIGS. 2 and 3 show some of the processing acts associated with the chemical oxide removal module and the thermal treatment module. In this regard, each block in the flow charts represents a process act associated with performing these modules. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe these processing acts may be added.

There are several advantages associated with having a temperature-controlled substrate holder within a chemical oxide removal that can maintain the substrate at an elevated temperature that ranges from about 10° C. up to about 150° C. One advantage is that this elevated temperature will result in better etching selectivity. As one skilled in the art adjusts the temperature of the sample, the reactivity of different materials changes according to the thermochemistry of the reaction. If an etch reaction requires a thermal bump to allow a reaction to occur, that process would benefit from a temperature increase. Another advantage of having a substrate holder that can maintain an elevated temperature range in a chemical oxide removal module is that increased etching will occur. Etch rates according to the Arrhenius equation for reaction rates states that temperature plays a role in reaction rates and efficiency. A third advantage that this elevated temperature range will have is more of a selection of etching materials.

It is apparent that there has been provided with this disclosure, an elevated temperature chemical oxide removal module and process. While the disclosure has been particularly shown and described in conjunction with a preferred embodiment thereof, it will be appreciated that a person of ordinary skill in the art can effect variations and modifications without departing from the scope of the disclosure.

What is claimed is:

1. A chemical oxide removal module, comprising:
a chemical treatment chamber configured to execute a chemical oxide removal process on a substrate;
a temperature-controlled substrate holder mounted within the chemical treatment chamber, wherein the temperature-controlled substrate holder is configured to maintain the substrate at a temperature that ranges from about 10° C. up to about 150° C. during execution of the chemical oxide removal process.

2. The chemical oxide removal module according to claim 1, wherein the temperature-controlled substrate holder comprises a high temperature substrate chuck.

3. A semiconductor treatment processing system for treating a substrate, comprising:
a chemical oxide removal module for executing a chemical oxide removal process on a substrate, the chemical oxide removal module comprising a chemical treatment chamber and a temperature-controlled substrate holder mounted within the chemical treatment chamber, wherein the temperature-controlled substrate holder is configured to maintain the substrate at a temperature that ranges from about 10° C. up to about 150° C. during execution of the chemical oxide removal process; and
a thermal treatment module for thermally treating the substrate after the chemical oxide removal module executes the chemical oxide removal process on the substrate.

4. The semiconductor processing system according to claim 3, wherein the temperature-controlled substrate holder in the chemical oxide removal module comprises a high temperature substrate chuck.

5. A chemical oxide removal process, comprising:
securing a substrate to a temperature-controlled substrate holder mounted within a chemical treatment chamber;
adjusting the temperature-controlled substrate holder to an elevated temperature, wherein the elevated temperature ranges from about 10° C. up to about 150° C.;
supplying one or more process gases to the chemical treatment chamber; and
exposing the substrate with the one or more process gases while the substrate is maintained at the elevated temperature for a predetermined amount of time.

6. The chemical oxide removal process according to claim 5, wherein the adjusting of the temperature-controlled substrate holder to an elevated temperature comprises selecting a temperature value that is in accordance with desired selectivity and etch rate parameters.

7. The semiconductor device according to claim 5, wherein the securing of the substrate to the temperature-controlled substrate holder comprises using a high temperature substrate chuck.
